(19) United States
(12) Patent Application Publication
(10) Pub. No.: US 2017/0279871 A1
(43) Pub. Date: Sep. 28, 2017

(54) INTER-REGIONAL FILE SHARING METHOD AND SYSTEM

(71) Applicants: LE HOLDINGS (BEIJING) CO., LTD., Beijing (CN); LECLOUD COMPUTING CO., LTD., Beijing (CN)

(72) Inventor: Xingyi WU, Beijing (CN)

(21) Appl. No.: 15/246,235

(22) Filed: Aug. 24, 2016

Related U.S. Application Data
(63) Continuation of application No. PCT/CN2016/088819, filed on Jul. 6, 2016.

(30) Foreign Application Priority Data
Mar. 28, 2016 (CN) 201610184537.7

(51) Int. Cl. H04L 29/08

(52) U.S. Cl. CPC H04L 67/06; H04L 67/32; H04L 67/1097

(57) ABSTRACT

An inter-regional file sharing method and system are provided. The method includes: configuring, in a first region, a first server and a first cloud storage cluster having a first domain name interface; and acquiring, by the first server, a file to be shared via the first domain name interface from the first cloud storage cluster and/or locally and transmitting the acquired file to be shared to a cloud cluster in a second region.

### CROSS REFERENCE TO RELATED APPLICATIONS

This application is a continuation of International Application No. PCT/CN2016/088819, filed on Jul. 6, 2016, which is based upon and claims priority to Chinese Patent Application No. 201610184537.7, filed on Mar. 28, 2016, the entire contents of which are incorporated herein by reference.

### TECHNICAL FIELD

Embodiments of the present disclosure relate to the technical field of file sharing, and in particular to an inter-regional file sharing method and system.

### BACKGROUND

With the development of social economy, inter-regional file sharing has become a new urgent need and has drawn increasing attention. In the process of implementing the present disclosure, the inventor found that the existing inter-regional file sharing is based on conventional servers, has a limited capacity for storing and sharing files, and has a very low transmission speed due to inter-regional network resource limitation.

### SUMMARY

In one aspect, the embodiments of the present disclosure provide an inter-regional file sharing method. The method includes: configuring, in a first region, a first server and a first cloud storage cluster having a first domain name interface; and acquiring, by the first server, a file to be shared via the first domain name interface from the first cloud storage cluster and/or locally and transmitting the acquired file to be shared to a cloud cluster in a second region.

In another aspect, the embodiments of the present disclosure provide an inter-regional file sharing system, including: a first server configured in a first region, a first cloud storage cluster configured in the first region and having a first domain name interface, and a cloud cluster configured in a second region, wherein the first server includes a file sharing module configured to acquire a file to be shared via the first domain name interface from the first cloud storage cluster and/or locally and transmit the acquired file to be shared to the cloud cluster in the second region.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of an inter-regional file sharing method according to an embodiment of the disclosure;

FIG. 2 is a schematic structural view of an inter-regional file sharing system according to an embodiment of the present disclosure;

FIG. 3 is a schematic structural view of a computer system of an electronic device which is the first/second server for implementing the inter-regional file sharing method according to the embodiment of the present disclosure.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

Embodiments of the present disclosure provide an inter-regional file sharing method and system, in order to solve the problem that the conventional inter-regional filing sharing has a limited storage capacity and a low transmission speed and to realize inter-regional filing sharing having a massive storage space and a high transmission speed.

The inter-regional file sharing method and system provided by the embodiments of the present disclosure enable massive-space file sharing by configuring cloud clusters in the first region and the second region between which files are shared. The file to be shared may be acquired from either a cloud network or a local server to satisfy a user's needs very conveniently. Moreover, in the embodiments of the disclosure, a user in the second region downloads a file directly from the cloud cluster in the second region, thereby making it faster to acquire the file and improving user experience.

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

In the following, embodiments of the disclosure will be described in further detail in conjunction with the drawings.

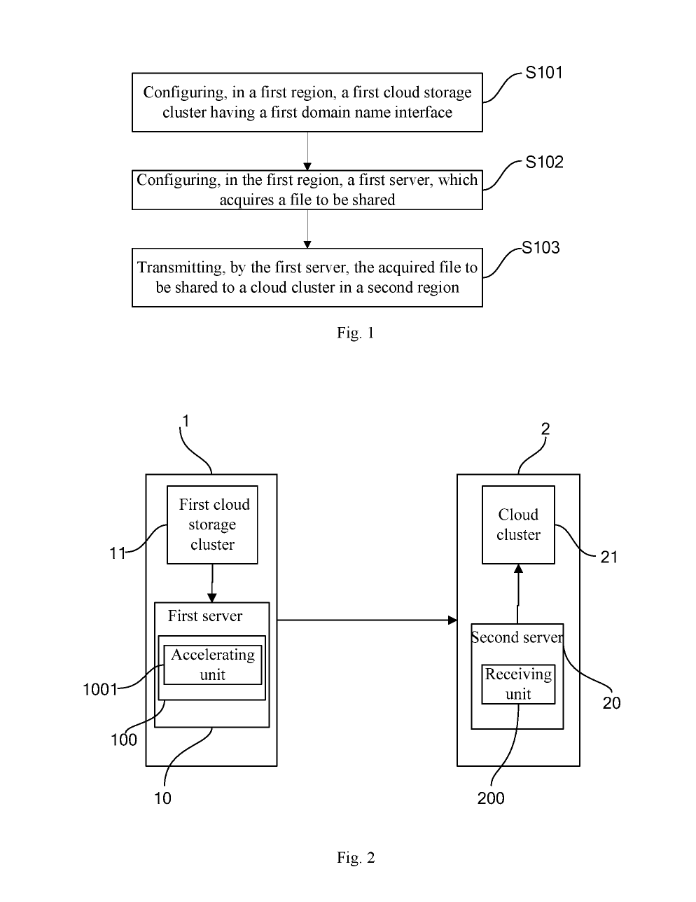

FIG. 1 schematically illustrates a flowchart of an inter-regional file sharing method according to an embodiment of the disclosure. As shown in FIG. 1, the method includes the following steps.

In step S101, a first cloud storage cluster having a first domain name interface is configured in a first region.

The first cloud storage cluster is configured in the first region for storing files to be shared. The first cloud storage cluster can provide a cloud object storage service and provide users with the storage service via the first domain name interface. Users can store files to be shared to the first cloud storage cluster via the first domain name interface.

In step S102, a first server is configured in the first region. A file to be shared is acquired by the first server.

The first server is configured in the first region for transferring files. After the first server is configured, files to be shared can be transferred through the first server. The first server may acquire a file to be shared from either first cloud storage cluster or locally. The first server can download and acquire the file to be shared from the first cloud storage cluster via the first domain name interface.

In step S103, the first server transmits the acquired file to be shared to a cloud cluster in a second region.

After acquiring the file to be shared, the first server can transfer the file to be shared to the second region through a network. In the embodiment of the disclosure, a cloud cluster (i.e., a cloud storage cluster) is configured in the second region for providing a cloud object storage service. The cloud cluster provides users in the second region with downloading services via its domain name interface. After the first server transmits files to the cloud cluster in the second region, the users in the second region can download corresponding files from the cloud cluster via the domain name interface thereof. The first server can transmit a file to be shared to the cloud cluster in the second region by configuring a second server in the second region. The first server first transmits the file to the second server, and then the second server uploads the file to the cloud cluster for storage.

With the method according to the embodiment of the disclosure, it is possible to provide a massive storage space for users sharing files between a first region and a second region. Also, users in the second region can download files directly from the cloud cluster in the second region, thereby increasing the speed of file acquisition and improving the user experience.

Preferably, when a file to be shared on the first server is transmitted to the second server, it is possible to accelerate the transmission via a wide area network so as to further increase the transmission speed of file sharing. The acceleration via the wide area network may be implemented by using prior art approaches for accelerating transmission, such as a forward error correction coding acceleration technology or a WDT (Warp speed Data Transfer) acceleration tool. In an embodiment of the disclosure, it is preferable to accelerate transmission by using the forward error correction coding technology. Specifically, the first server may encode an acquired file to be uploaded to convert it from TCP packets into UDP packets, and then transmit the UDP packets to the second server. After receiving the UDP packets, the second server may perform decoding to convert the UDP packets back into TCP packets. By using the UDP acceleration approach, even if a packet loss occurs during transmission (for example, among 11 packets to be transmitted to the second server, only 8 packets arrive at the second server), the correct file content can be acquired by performing forward error correction. That is, even if a packet loss occurs, the accuracy of the file will not be affected. Reference can be made to the prior art, for details of the process and mechanism of forward error correction, which will not be elaborated herein.

FIG. 2 schematically illustrates an architecture of an inter-regional file sharing system according to an embodiment of the disclosure. As shown in FIG. 2, the system includes: a first server 10 configured in a first region 1, a first cloud storage cluster 11 configured in the first region 1 and having a first domain name interface, and a cloud cluster 21 configured in a second region 2. The first cloud storage cluster 11 is configured to provide users in the first region with a space for storing files to be shared, the first server 10 is configured to transmit the files to be shared to the second region, and the cloud cluster 21 in the second region is configured to provide a storage space for the files to be shared. The first cloud storage cluster 11 provides uploading and downloading addresses for users in the first region and the first server via the first domain name interface, and the cloud cluster 21 provides users in the second region with an address for downloading files. The first server 10 includes a file sharing module 100 configured to acquire a file to be shared via the first domain name interface from the first cloud storage cluster 11 and/or locally and to transmit the acquired file to be shared to the cloud cluster 21 in the second region. With the system according to the embodiment of the disclosure, a massive storage space can be provided for users sharing files. Also, transmission by the first server ensures that users in the second region can download files via the domain name interface directly from the cloud cluster in the second region, thereby increasing the speed of downloading files, ensuring a high service quality and improving the user experience.

As shown in FIG. 2, the file sharing module 100 in the embodiment of the disclosure further includes: an accelerating unit 1001 configured to accelerate, via a wide area network, transmission of the file to be shared to the cloud cluster 21 in the second region. With the accelerating unit 1001 performing acceleration for the transmission, it is possible to effectively accelerate transmission of files to be shared from the first region to the second region, thereby realizing high-speed inter-regional file sharing. The wide area network acceleration technology used in the embodiment of the disclosure may be a forward error correction coding acceleration technology or a WDT acceleration tool. When the transmission is accelerated by using the forward error correction coding technology, the accelerating unit 1001 will perform encoding to convert an acquired file to be shared from TCP packets into UDP packets and transmit the encoded file to be shared represented by UDP packets to the second region. At this point, the second server 20 may be configured in the second region, and a receiving unit 200 may be provided on the second server 20 to decode the file represented by UDP packets resulting from conversion by the accelerating unit 1001 and upload the decoded file to the cloud cluster 21 for storage. Afterwards, a user can download the stored file to be shared via the domain name interface of the cloud cluster 21. By accelerating the transmission using the forward error correction coding technology, the accuracy of the file can be ensured even if a packet loss occurs.

The specific method and process for implementing the modules and units in the system according to the embodiment of the disclosure are the same as the above-described method, to which reference can be made.

Each of the first server and the second server in the inter-regional file sharing system according to the embodiment of the disclosure may be a server or cluster of servers, with each module/unit being an individual server or server cluster. In this case, interaction among the modules/units appears as interaction among servers or server clusters corresponding to the modules/units. The servers or server clusters together constitute the inter-regional file sharing system of the present disclosure.

It shall be noted that the first region in the method and system according to the embodiments of the disclosure is the region where the transmitting end of the file sharing is located and that the second region is the region where the receiving end of the file sharing is located. For example, if a file is shared from a country A to a country B, then country A is the first region and country B is the second region. If a file is shared from country B to country A, then country B is the first region and country A is the second region. In case there is a need for bi-directional sharing, the first server in the first region and the second server in the second region are configured in the same manner. That is, bi-direction transmission can be achieved by configuring an accelerating unit on the second server and configuring a receiving unit on the first server. Namely, it is possible and very convenient to either share a file on the first cloud storage cluster and the first server in the first region to the cloud cluster in the second region or share a file on the cloud cluster and the second server in the second region to the first cloud storage cluster in the first region.

Preferably, in order to ensure uploading and downloading speeds and the service quality, it is also possible to limit at the cloud times and priorities of users' uploading and downloading. In order to ensure effective use of the storage space, it is also possible to limit validity periods of files on the first cloud storage cluster and the cloud cluster, so that a file is allowed to be transmitted and shared only within its validity period and is allowed to be accessed and downloaded by users only within its validity period.

By configuring a first cloud storage cluster in a first region for storing a file to be shared and by transmitting by the first server the file to be shared to a cloud cluster in a second region, the method and system according to the embodiments of the disclosure allow a massive file sharing space to be provided for users, and can ensure that users download files from their own regions thereby increasing the speed of downloading files. Moreover, by configuring the first server and the second server in the first region and the second region to accelerate transmission, it is possible and very useful to further increase the speed of file sharing and shorten the time for inter-regional file sharing.

The present disclosure further provides a non-transitory computer-readable storage medium, in which one or more programs including execution instructions are stored, the execution instructions being executable by electronic devices having control interfaces for executing the related steps in the above method embodiments. For example, the steps include: acquiring a file to be shared via the first domain name interface from the first cloud storage cluster and/or locally and transmitting the acquired file to be shared to a cloud cluster in a second region; and/or receiving the file to be shared and uploading the file to be shared to the cloud cluster in the second region.

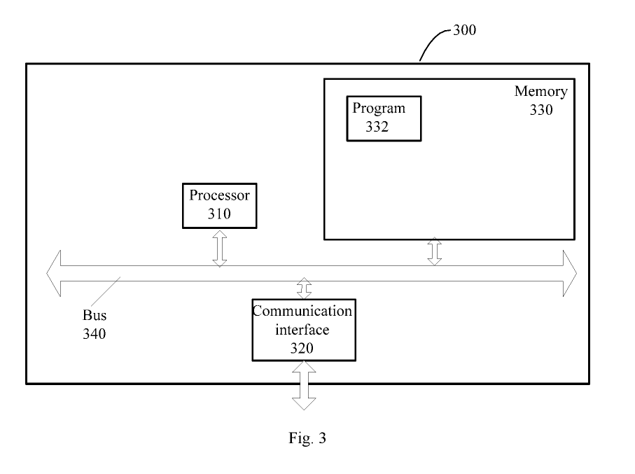

FIG. 3 is a schematic structural view of an electronic device 300 which is the first/second server for implementing the inter-regional file sharing method according to the embodiment of the present disclosure. The specific embodiments of the present disclosure do not define the specific implementation manners of the device 300. As shown in FIG. 3, the device 300 may include: a processor 310, a communications interface 320, a memory 330 and a communication bus 340.

Communications between the processor 310, the communications interface 320 and the memory 330 are accomplished via the communication bus 340.

The communications interface 320 is configured to communicate with a network element such as a client.

The processor 310 is configured to execute a program 332 in the memory 330, so as to execute the related steps in the above method embodiments.

In particular, the program 332 may include a program code which includes a computer operation instruction.

The processor 310 may be a Central Processing Unit (CPU), or an Application Specific Integrated Circuit (ASIC), or one or more integrated circuits configured to implement the embodiments of the present disclosure.

The memory 330 is configured to store the program 332. The memory 330 may include a high speed RAM memory, and may also include a non-volatile memory, such as at least one disk memory. The program 332 may in particular be configured to cause the device 300 to execute the following operations:

A file sharing step: acquiring a file to be shared via the first domain name interface from the first cloud storage cluster and/or locally and transmitting the acquired file to be shared to a cloud cluster in a second region; and/or

A shared file receiving step: receiving the file to be shared and uploading the file to be shared to the cloud cluster in the second region.

The specific realization of each step in the program 332 can be seen from the corresponding descriptions of the corresponding steps and units in the above embodiments, and will not be described herein. It can be understood by a person skilled in the art that for the convenience and conciseness of the description, the specific working processes of the above described device and modules can be seen from the foregoing descriptions of the corresponding processes in the method embodiments, and will not be described herein.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. An inter-regional file sharing method, comprising:
configuring, in a first region, a first server and a first cloud storage cluster having a first domain name interface; and
acquiring, by the first server, a file to be shared via the first domain name interface from the first cloud storage cluster and/or locally and transmitting the acquired file to be shared to a cloud cluster in a second region.

2. The method according to claim 1, wherein the first server accelerates via a wide area network transmission of the file to be shared to the cloud cluster in the second region.

3. The method according to claim 2, wherein the acceleration via the wide area network is forward error correction coding acceleration or Warp speed Data Transfer (WDT) acceleration.

4. The method according to claim 3, wherein when the acceleration via the wide area network is the forward error correction coding acceleration, accelerating by the first server, via the wide area network, transmission of the file to be shared to the cloud cluster in the second region comprises:
encoding, by the first server, the acquired file to be shared and sending the encoded file to be shared to a second server in the second region; and
decoding, by the second server, a received file and uploading the decoded file to the cloud cluster for storage.

5. The method according to claim 4, wherein encoding, by the first server, the file to be shared and transmitting the encoded file to be shared to a second server in the second region comprises:
converting, by the first server, the file be to shared from TCP packets into UDP packets and transmitting the UDP packets to the second server; and
decoding, by the second server, the received file and uploading the decoded file to the cloud cluster for storage comprises: converting, by the second server, the received UDP packets into a file represented by TCP packets and uploading the file represented by TCP packets to the cloud cluster for storage.

6. An inter-regional file sharing system, comprising: a first server configured in a first region, a first cloud storage cluster configured in the first region and having a first domain name interface, and a cloud cluster configured in a second region, wherein
the first server comprises at least one processor configured to acquire a file to be shared via the first domain name interface from the first cloud storage cluster and/or locally and to transmit the acquired file to be shared to the cloud cluster in the second region.

7. The system according to claim 6, wherein the at least one processor is configured to accelerate, via a wide area network, transmission of the file to be shared to the cloud cluster in the second region.

8. The system according to claim 7, wherein the acceleration via the wide area network is forward error correction coding acceleration or WDT acceleration.

9. The system according to claim 8, wherein when the acceleration via the wide area network is the forward error correction coding acceleration, the system further comprises a second server configured in the second region;
the at least one processor is configured to encode the acquired file to be shared and transmit the encoded file to be shared to the second server in the second region; and
the second server is configured to decode the received file and upload the decoded file to the cloud cluster for storage.

10. The system according to claim 9, wherein the at least one processor is configured to convert the file be to shared from TCP packets into UDP packets and transmit the UDP packets to the second server; and
the second server is configured to convert the received UDP packets into a file represented by TCP packets and upload the file represented by TCP packets to the cloud cluster for storage.

11. A non-transitory computer-readable storage medium storing executable instructions, wherein the executable instructions, when executed by an electronic system comprising one or more processors, cause the electronic system to:
configure, in a first region, a first server and a first cloud storage cluster having a first domain name interface; and
acquire a file to be shared via the first domain name interface from the first cloud storage cluster and/or locally and transmitting the acquired file to be shared to a cloud cluster in a second region.

12. The non-transitory computer-readable storage medium of claim 11, wherein the executable instructions, when executed by the electronic system, further cause the electronic system to:
accelerate, via a wide area network, transmission of the file to be shared to the cloud cluster in the second region.

13. The non-transitory computer-readable storage medium of claim 12, wherein the executable instructions, when executed by the electronic system, further cause the electronic system to:
accelerate the transmission using one of forward error correction coding acceleration and WDT acceleration.

14. The non-transitory computer-readable storage medium of claim 13, wherein the executable instructions, when executed by the electronic system, further cause the electronic system to:
encode the acquired file to be shared and transmitting the encoded file to be shared to a second server in the second region; and
decode the received file and uploading the decoded file to the cloud cluster for storage.

15. The non-transitory computer-readable storage medium of claim 14, wherein the executable instructions, when executed by the electronic system, further cause the electronic system to:
convert the file be to shared from TCP packets into UDP packets and transmitting the UDP packets to the second server; and
convert the received UDP packets into a file represented by TCP packets and uploading the file represented by TCP packets to the cloud cluster for storage.
